(19) United States
(12) Patent Application Publication
(10) Pub. No.: US 2016/0368500 A1
(43) Pub. Date: Dec. 22, 2016

(54) METHOD FOR CONTROLLING ENTRY TO FULL LOAD MODE OF ENGINE IN HYBRID ELECTRIC VEHICLE

(71) Applicant: Hyundai Motor Company, Seoul (KR)

(72) Inventors: Hong Kee Sim, Seoul (KR); Dong Jun Shin, Hwaseong (KR)

(21) Appl. No.: 14/947,623

(22) Filed: Nov. 20, 2015

(30) Foreign Application Priority Data
Jun. 22, 2015 (KR) 10-2015-0088270

(51) Int. Cl. B60W 30/20; B60W 30/02; B60W 10/12; B60K 6/442; B60W 20/15

(52) U.S. Cl. CPC B60W 30/20; B60K 6/442; B60W 20/15; B60W 10/12; B60W 30/02; Y10S 903/903; B60Y 2200/92; B60Y 2300/182

(57) ABSTRACT

The present disclosure relates to a method for controlling entry to a full load mode of an engine in a hybrid electric vehicle including: determining an anti-jerk torque margin value using an anti-jerk torque value monitored in real-time; determining a filter gain value selected from a filter gain command table; and determining whether to activate a full load mode of the engine based on a value obtained by subtracting the determined anti-jerk torque margin value from an assisting torque value of a motor of the vehicle that assists an output of the engine.

### CROSS-REFERENCE TO RELATED APPLICATION

This application claims under 35 U.S.C. §119(a) the benefit of and priority to Korean Patent Application No. 10-2015-0088270 filed on Jun. 22, 2015, the entire contents of which being incorporated herein by reference.

### BACKGROUND

(a) Technical Field

The present disclosure relates generally to a method for controlling entry to a full load mode of an engine in a hybrid electric vehicle. More particularly, it relates to a method for controlling entry to a full load mode of an engine in a hybrid electric vehicle, by which fuel ratio is enhanced by improving an entry condition of a full load mode of the engine of the hybrid electric vehicle.

(b) Background Art

Hybrid electric vehicles are vehicles that use an engine and a driving motor as two power sources. Hybrid vehicles can assist an output of the engine if power is required and can perform a charging operation if the battery is able to be charged according to particular driving circumstances.

The driving modes of the hybrid electric vehicle are classified into a part load mode and a full load mode according to load degrees of the engine. In the full load mode, a maximum performance of the engine is pursued. Thus, the efficiency of the engine is abruptly lowered and fuel consumption is rapidly increased. In a conventional hybrid electric vehicle, a condition of initiating the full load mode is satisfied if a torque required by the driver is higher than a sum of a maximum torque that may be output in a part load mode (hereinafter referred to as ‘a part load maximum torque of the engine’) and a motor assisting torque that may assist an output of the engine through assistance. That is, as illustrated in FIG. 1, “Full Load Mode Entry Condition=Driver Required Torque>Engine Part Load Maximum Torque+Motor Assisting Torque”.

In detail, the current full load mode entry condition is “Engine Part Load Maximum Torque+(Motor Assisting Torque−Anti-jerk Torque Margin)”. An anti-jerk torque margin value should be considered when a full load mode entry condition is determined because an anti-jerk torque (i.e., Ant-Jerk TQ) is restricted by a motor assisting torque during driving the vehicle so that a shock or a jerk is generated during driving the vehicle, and thus hampers driving efficiency, if the anti-jerk torque margin (Anti-Jerk TQ Margin) is not considered. Because an anti-jerk torque margin value is currently fixed as a constant value, the vehicle may enter the full load mode, and a fuel ratio may be lowered if the anti-jerk torque margin value is conservatively set to a large value. Meanwhile, a shock or jerk phenomenon may be caused in the vehicle if the anti-jerk torque margin value is set to a small value. As known, generally, the anti-jerk torque is a torque considered when an output torque of the motor is controlled to prevent a shock or jerk phenomenon while driving the vehicle, and the anti-jerk torque margin is determined based on an anti-jerk torque value.

The above information disclosed in this Background section is only for enhancement of understanding of the background of the disclosure, and therefore, it may contain information that does not form the related art that is already known in this country to a person of ordinary skill in the art.

### SUMMARY OF THE DISCLOSURE

The present disclosure has been made in an effort to solve the above-mentioned problems, and provides a method for controlling entry to a full load mode of an engine in a hybrid electric vehicle, which can prevent deterioration of fuel ratio by lowering the possibility of entry to a full load mode of an engine using a table mapped in advance. As a result, table values can vary according to an anti-jerk torque monitored in real-time, and a travel situation of the vehicle instead of using an existing predetermined constant value as an anti-jerk torque margin used when a condition for entry to a full load mode of the engine is determined.

According to embodiments of the present disclosure, a method for controlling entry to a full load mode of an engine in a hybrid electric vehicle includes: determining an anti-jerk torque margin value using an anti-jerk torque value monitored in real-time; determining a filter gain value selected from a filter gain command table; and determining whether to activate a full load mode of the engine based on a value obtained by subtracting the determined anti-jerk torque margin value from an assisting torque value of a motor of the vehicle that assists an output of the engine.

The filter gain command table is configured such that the filter gain value is determined based on a tip-in situation, a gearshift situation, and current gear stage information, and the anti-jerk torque margin is determined by a value obtained by multiplying the anti-jerk torque value and a filter gain value.

The method may further include determining the anti-jerk torque margin value according to a value obtained by multiplying the anti-jerk torque value by the filter gain value.

The method may further include determining whether to activate the full load mode of the engine by comparing a torque required by a driver of the vehicle with a sum of a value obtained by subtracting the anti-jerk torque margin value from the assisting torque value of the motor and a part load maximum torque of the engine.

Furthermore, according to embodiments of the present disclosure, a non-transitory computer readable medium containing program instructions for controlling entry to a full load mode of an engine in a hybrid electric vehicle includes: program instructions that determine an anti-jerk torque margin value using an anti-jerk torque value monitored in real-time; program instructions that determine a filter gain value selected from a filter gain command table; and program instructions that determine whether to activate a full load mode of the engine based on a value obtained by subtracting the determined anti-jerk torque margin value from an assisting torque value of a motor of the vehicle that assists an output of the engine.

According to the present disclosure, the frequency of entries to a full load mode of an engine can be minimized, and deterioration of fuel ratio can be prevented without hampering driving efficiency through an optimum control of an anti-jerk torque margin value using a table mapped in advance, such that table values may vary according to an anti-jerk torque monitored in real-time and a travel situation of the vehicle.

Other aspects and preferred embodiments of the disclosure are discussed infra.

### BRIEF DESCRIPTION OF THE DRAWINGS

The above and other features of the present disclosure will now be described in detail with reference to certain embodiments thereof illustrated by the accompanying drawings which are given herein below by way of illustration only, and thus are not limitative of the present disclosure, and wherein:

FIG. 1 illustrates a condition for controlling entry to a full load mode of an engine in a hybrid electric vehicle according to the related art.

FIG. 2 illustrates a condition for controlling entry to a full load mode of an engine in a hybrid electric vehicle according to the present disclosure.

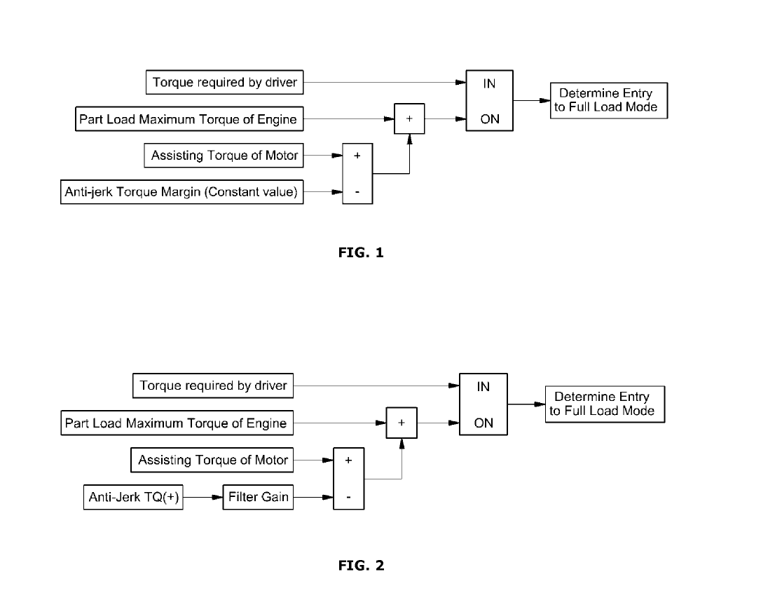

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with embodiments, it will be understood that present description is not intended to limit the disclosure to those embodiments. On the contrary, the disclosure is intended to cover not only the embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art.

Furthermore, the controller of the present disclosure may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

As mentioned above, because an anti-jerk torque margin value is currently fixed as a constant value, the vehicle may enter a full load mode and fuel ratio may be lowered if the anti-jerk torque margin value is conservatively set to a large value. A shock or jerk phenomenon may be caused if the anti-jerk torque margin value is set to a small value. That is, there is conventionally a limit in the aspect of control in setting an anti-jerk torque margin value to a constant value or mapping with a table constructed in advance. Because vehicles have slightly different inertias due to their hardware characteristics and the degree of applied anti-jerk torques varies according to driving habits (for example, a radical tip-in/out and the like), mapping values should be conservatively set to cover all situations.

Accordingly, the present disclosure uses anti-jerk toques applied in real-time and determines an anti-jerk torque margin value using table values mapped in advance in consideration of travel situations in which filter gain values are not a constant value, thereby minimizing a frequency of entries into a full load mode of the engine by optimally controlling the anti-jerk torque margin and preventing fuel ratio from falling according to the entry to the full load mode.

Referring now to FIG. 2 illustrates a condition for controlling entry to a full load mode of an engine in a hybrid electric vehicle according to the present disclosure.

As illustrated in FIG. 2, a condition for determining entry to a full load mode of an engine, that is, determining whether to activate the full load mode of the engine, is “Part load Maximum Torque of Engine+(Assisting Torque of Motor−Anti-jerk Torque Margin)”, in detail, “Part load Maximum Torque of Engine+[Assisting Torque of Motor−(Anti-jerk Torque*Filter Gain)]”. The anti-jerk torque is applied and determined by a motor controller when an output torque of a motor is controlled, to prevent a shock or jerk phenomenon during driving the vehicle, and the anti-jerk torque margin is determined by the motor controller as a value obtained by multiplying the anti-jerk torque value by the filter gain value.

Here, an anti-jerk torque value monitored in real-time during driving the vehicle is used as the anti-jerk torque value, and only an anti-jerk torque of a positive value (+) is used. The filter gain value is used to prevent a situation in which an actual assisting torque of the motor is abruptly changed when the anti-jerk torque of a high value is instantaneously applied.

The actual assisting torque of the motor is a substantially assisting torque of the motor that may include a vibration component when a vibration situation such as a shock and a jerk is generated during driving the vehicle, and is a value obtained by subtracting “(Anti-jerk Torque*Filter Gain)” from a assisting torque of the motor that may assist an output of the engine through assistance. Accordingly, the entry to the full load mode is determined according to a result of comparing a value obtained by adding the part load maximum torque of the engine and the actual assisting torque of the motor with a torque required by the driver.

Table values mapped and constructed in advance in consideration of a travel situation of the vehicle, i.e., values of a filter gain command table, are used as the filer gain value. The travel situation considered when the filter gain command table is constructed is a travel situation that influences a vibration situation such as a shock and a jerk, which is generated during driving the vehicle, and includes, for example, a tip-in situation in which an accelerator pedal is repeatedly stepped on, a gearshift situation, or the like. The filter gain value is changed and determined according to current gear stage information in the situation. That is, the filter gain command table determines a filter gain value based on a travel situation, i.e., a condition or reference such as a current gear stage (see Table 1). The filter gain command table may be constructed as a 2D filter gain command table based on a travel situation, such as a tip-in or a gearshift and information such as a current gear stage. In addition, the filter gain command table may be stored by the motor controller.

TABLE 1

Current Gear Stage

| Filter Gain | Low stage gear (1~3) | High stage gear (4~6) |
|---|---|---|
| Tip-in | A (Large) | B (Middle) |
| Gearshift | B (Middle) | C (Small) |
| Others | C (Small) | C (Small) |

As illustrated in Table 1, the current gear stage may be applied to construct a filter gain command table in a condition in which set gear stages of the vehicle are classified into a plurality of groups from the lowest stage to the highest stage, and may be applied in a condition in which the gear stages are divided into low stage gears and high stage gears. Referring still to Table 1, as an example, A is selected as a filter gain value if the current gear stage is a low gear stage, and B is selected as the filter gain value if the current gear stage is a high gear stage in a tip-in situation during driving the vehicle. B is selected as the filter gain value if the current gear stage is a low gear stage, and C is selected as the filter gain value if the current gear stage is a high gear stage in a gearshift situation during driving the vehicle. Finally, C is selected as the filter gain value regardless of the gear stage in a non-tip-in/gear shaft situation. Then, the filter gain value may be A>B>C.

The gain value of the anti-jerk torque monitored in real-time may be variously selected with the filter gain value selected by determining the travel situation. That is, the filter gain value of the anti-jerk torque may be determined using the filter gain command table constructed in advance.

As illustrated in FIG. 2, the anti-jerk torque margin value is determined in real-time using the anti-jerk torque value monitored in real-time and the filter gain value of the anti-jerk torque, and the entry to the full load mode of the engine is determined according to a result of comparing a torque required by the driver of the vehicle with the sum of a value obtained by subtracting the anti-jerk torque margin value determined in real-time from the assisting torque of the motor (i.e., the actual assisting torque of the motor) and the part load maximum torque of the engine. This way, because the anti-jerk torque margin is optimally controlled using the anti-jerk torque value monitored in real-time, and the filter gain value mapped according to a travel situation, the frequency of the entries to the full load mode of the engine may be reduced and deterioration of fuel ratio according to the entry to the full load mode may be prevented.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for controlling entry to a full load mode of an engine in a hybrid electric vehicle, the method comprising:
determining an anti-jerk torque margin value using an anti-jerk torque value monitored in real-time;
determining a filter gain value selected from a filter gain command table; and
determining whether to activate a full load mode of the engine based on a value obtained by subtracting the determined anti-jerk torque margin value from an assisting torque value of a motor of the vehicle that assists an output of the engine.

2. The method of claim 1, wherein the filter gain command table is configured such that the filter gain value is determined based on a tip-in situation, a gearshift situation, and current gear stage information.

3. The method of claim 1, further comprising:
determining the anti-jerk torque margin value according to a value obtained by multiplying the anti-jerk torque value by the filter gain value.

4. The method of claim 1, further comprising:
determining whether to activate the full load mode of the engine by comparing a torque required by a driver of the vehicle with a sum of a value obtained by subtracting the anti-jerk torque margin value from the assisting torque value of the motor and a part load maximum torque of the engine.

5. A non-transitory computer readable medium containing program instructions for controlling entry to a full load mode of an engine in a hybrid electric vehicle, the computer readable medium comprising:
program instructions that determine an anti-jerk torque margin value using an anti-jerk torque value monitored in real-time;
program instructions that determine a filter gain value selected from a filter gain command table; and
program instructions that determine whether to activate a full load mode of the engine based on a value obtained by subtracting the determined anti-jerk torque margin value from an assisting torque value of a motor of the vehicle that assists an output of the engine.

6. The computer readable medium of claim 5, wherein the filter gain command table is configured such that the filter gain value is determined based on a tip-in situation, a gearshift situation, and current gear stage information.

7. The computer readable medium of claim 5, further comprising:
program instructions that determine the anti-jerk torque margin value according to a value obtained by multiplying the anti-jerk torque value by the filter gain value.

8. The computer readable medium of claim 5, further comprising:
program instructions that determine whether to activate the full load mode of the engine by comparing a torque required by a driver of the vehicle with a sum of a value obtained by subtracting the anti-jerk torque margin value from the assisting torque value of the motor and a part load maximum torque of the engine.
